(19) United States
(12) Patent Application Publication
(10) Pub. No.: US 2009/0016056 A1
(43) Pub. Date: Jan. 15, 2009

(54) ELECTRONIC DEVICE

(75) Inventors: Shinichi Morikita, Kanagawa (JP); Tetsuya Kubo, Kanagawa (JP); Makoto Tamaru, Kanagawa (JP); Norio Okada, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/814,734

(22) PCT Filed: Jan. 27, 2006
(86) PCT No.: PCT/JP2006/301282

§ 371 Date: Jun. 2, 2008

(30) Foreign Application Priority Data
Jan. 28, 2005 (JP) 2005-021630

(51) Int. Cl. F21V 33/00

(52) U.S. Cl. 362/253

(57) ABSTRACT

Herein disclosed is an electronic device which can have, without deteriorating the effect of notification by light, an extended area to have electronic parts mounted thereon at the portion of the main body 20 covered with the accessory exterior panel 30, the extended area being extended in size compared with the conventional electronic device, the electronic device available for a cellular phone. The cellular phone 10 comprises a main body 20, an accessory exterior panel 30 detachably mounted on the main body 20, and four screws 50 for fixing the accessory exterior panel 30 to the main body 20. The main body 20 has LEDs and a light guide plate 22c irradiated by the LEDs. The light guide plate 22c is positioned to emit a light to the inner portion of the accessory exterior panel 30 through the side surface 30a of the accessory exterior panel 30.

### TECHNICAL FIELD

The present invention relates to an electronic device having an accessory exterior panel detachably mounted thereon.

### BACKGROUND ART

Up until now, there has been proposed a conventional cellular phone, as an electronic device, comprising a main display unit having an incoming call notification display portion having a light emitting device for emitting a light representing an incoming call notification when there is an incoming call, and an accessory exterior panel to cover the display portion detachably mounted on the main display unit, wherein the light emitted from the light emitting device is guided to the inner portion of the accessory exterior panel, which results in the light illuminating the display pattern formed on the accessory exterior panel (see patent document 1).

There has also been proposed another conventional cellular phone comprising an upper case having a surface emitting device having a flat surface, and a panel member attached to the outside surface of the upper case for covering the surface emitting device, wherein the light emitted from the surface emitting device is guided to the inner portion of the panel member, which results in changing the appearance of the display pattern displayed on the panel member (see patent document 2).

Patent document 1: Japanese Patent Laying-Open Publication No. 2002-125016 (pp. 6-7, FIGS. 6 and 7)
Patent document 2: Japanese Patent Laying-Open Publication No. 2004-80390 (pp. 5 and 9, FIGS. 1 to 3 and 14)

### DISCLOSURE OF THE INVENTION

### Problems to be Solved by the Invention

The aforementioned conventional cellular phones, however, encounter such a problem that, though it is possible to effectively notify a user of an incoming phone call by having the surface emitting device illuminate the whole panel, the portion covered with the accessory exterior panel is small in size to have electronic parts mounted thereon other than the incoming call notification display portion, and the portion covered with the panel member is small in size to have electronic parts mounted thereon other than the surface emitting device. This results from the fact that the incoming call notification display portion is placed at the portion of the main display unit, the portion covered with the accessory exterior panel, while the surface emitting device is placed at the portion of the upper case, the portion covered with the panel member.

It is, therefore, an object of the present invention to provide a cellular phone which can effectively notify a user of an incoming phone call while having an extended area to have electronic parts mounted thereon at the portion of the main body covered with the accessory exterior panel.

### Means for Solving the Problems

In accordance with the present invention, there is provided an electronic device, comprising: a main body having a light emitting portion; and an accessory exterior panel having a side surface and detachably mounted on the main body with the side surface held in face-to-face relationship with the light emitting portion, the light emitting portion positioned in the main body to emit a light to the inner portion of the accessory exterior panel through the side surface of the accessory exterior panel.

The electronic device according to the present invention can have, without deteriorating the effect of notification by light, an extended area to have electronic parts mounted thereon at the portion of the main body covered with the accessory exterior panel, the extended area being extended in size compared with the conventional electronic device. This stems from the fact that the light emitting portion is positioned to emit the light to the inner portion of the accessory exterior panel through the side surface of the accessory exterior panel.

In accordance with the present invention, there is provided an electronic device, in which the accessory exterior panel has an inclined surface formed on a path of the light emitted to the inner portion of the accessory exterior panel from the light emitting portion through the side surface.

The electronic device according to the present invention can reflect, by the inclined surface of the accessory exterior panel, the light transmitted from the side surface of the accessory exterior panel to the inner portion of the accessory exterior panel, and can output the reflected light from the accessory exterior panel. This makes it possible for the electronic device to have the specific area of the outside surface of the accessory exterior panel shone more brightly, the specific area close to the inclined surface.

In accordance with the present invention, there is provided an electronic device, in which the accessory exterior panel has an inside surface held in contact with the main body and partly light reflectable.

The electronic device according to the present invention can reflect, by the inside surface having light-reflectivity, the light transmitted from the side surface of the accessory exterior panel to the inner portion of the accessory exterior panel, and can output the reflected light from the accessory exterior panel. This makes it possible for the electronic device to have the outside surface of the accessory exterior panel shone more brightly.

In accordance with the present invention, there is provided an electronic device, in which the accessory exterior panel has an outside surface opposite to the inside surface and partly light shieldable.

The electronic device according to the present invention can output the light from the inner portion of the accessory exterior panel only through the outside surface of the accessory exterior panel where light shielding is not processed. This makes it possible for the electronic device to have the specific area of the outside surface of the accessory exterior panel shone more brightly.

In accordance with the present invention, there is provided an electronic device, in which the accessory exterior panel has an outside surface opposite to the inside surface partly light permeable and colored.

The electronic device according to the present invention can partly output the light from the inner portion of the accessory exterior panel through the colored part of the outside surface of the accessory exterior panel. This makes it possible for the electronic device to have the colored part of the outside surface of the accessory exterior panel shone with color.

In accordance with the present invention, there is provided an electronic device, comprising: a main body having a light emitting portion; a first accessory exterior panel having a side surface and detachably mounted on the main body with the side surface held in face-to-face relationship with the light emitting portion; and a second accessory exterior panel detachably mounted on the first accessory exterior panel, the light emitting portion positioned in the main body to emit a light to the inner portion of the first accessory exterior panel from the side surface of the first accessory exterior panel, and the first accessory exterior panel functioning as a light guiding member for guiding the light from the light emitting portion to the second accessory exterior panel.

The electronic device according to the present invention can have, without deteriorating the effect of notification by light, an extended area to have electronic parts mounted thereon at the portion of the main body covered with the first accessory exterior panel, the extended area being extended in size compared with the conventional electronic device. This stems from the fact that the light emitting portion is positioned to emit the light to the inner portion of the first accessory exterior panel through the side surface of the first accessory exterior panel. In addition, the electronic device can make the outside surface of the second accessory exterior panel shone more brightly compared with the electronic device having only one accessory exterior panel. This results from the fact that the first accessory exterior panel can direct the light, the light being incident to the inner portion of the first accessory exterior panel through the side surface of the first accessory exterior panel, to the inner portion of the second accessory exterior panel through the inside surface of the second accessory exterior panel.

### ADVANTAGEOUS EFFECT OF THE INVENTION

The electronic device according to the present invention makes it possible to have, without deteriorating the effect of notification by light, an extended area to have electronic parts mounted thereon at the portion of the main body covered with the accessory exterior panel, the extended area being extended in size compared with the conventional electronic device.

### BRIEF DESCRIPTION OF THE DRAWINGS

FIG. 1 is a developed view showing the cellular phone according to the first embodiment of the present invention;

FIG. 2 is an external perspective view showing the cellular phone shown in FIG. 1;

FIG. 3 is a developed view showing the main body of the cellular phone shown in FIG. 1;

FIG. 4 is a fragmentary side cross-sectional view showing the cellular phone shown in FIG. 1;

FIG. 5 is a fragmentary side cross-sectional view showing the cellular phone shown in FIG. 1 comprising an accessory exterior panel with the printing process worked on the outside surface;

FIG. 6 is a fragmentary side cross-sectional view showing the cellular phone shown in FIG. 1 as an example different from that shown in FIG. 4;

FIG. 7 is a fragmentary side cross-sectional view showing the cellular phone according to the first embodiment of the present invention as an example different from that shown in FIG. 1; and

FIG. 8 is a fragmentary side cross-sectional view showing the cellular phone according to the second embodiment of the present invention.

### DESCRIPTION OF THE REFERENCE NUMERALS

10: cellular phone (electronic device)
20: main body
22c: light guide plate (light emitting portion)
22e: LED (light emitting portion)
30: accessory exterior panel
30a: side surface
30b: outside surface
30c: inside surface
30h, 30i: inclined surface
60: cellular phone (electronic device)
70: accessory exterior panel (first accessory exterior panel)
70a: outside surface
80: accessory exterior panel (second accessory exterior panel)

### DESCRIPTION OF THE PREFERRED EMBODIMENTS

The embodiments of the cellular phone according to the present invention will now be described in detail in accordance with accompanying drawings.

### First Embodiment

The constitution of the electronic device according to the first embodiment of the present invention will hereinafter be described in detail.

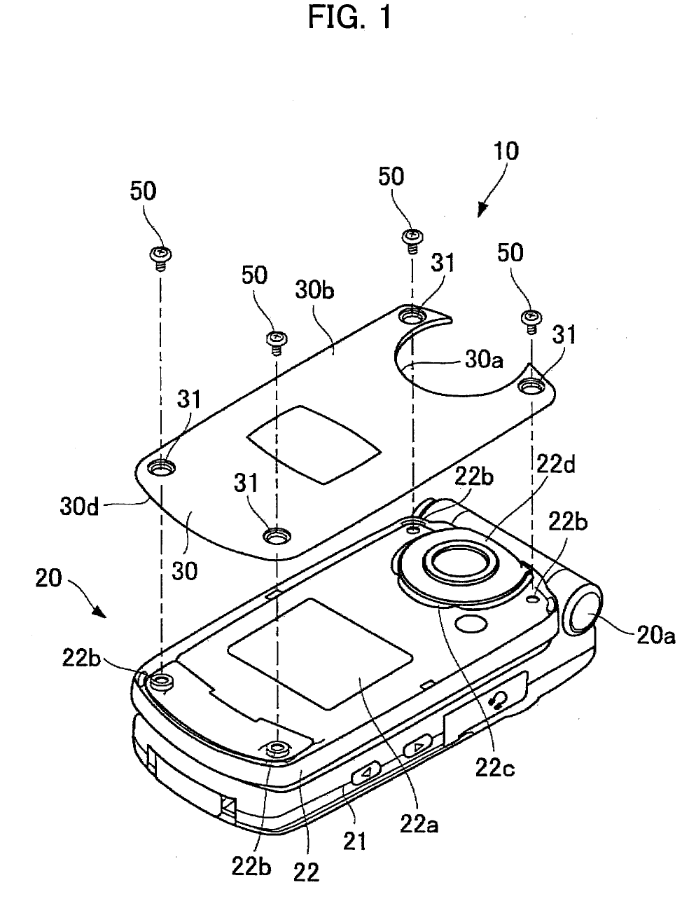

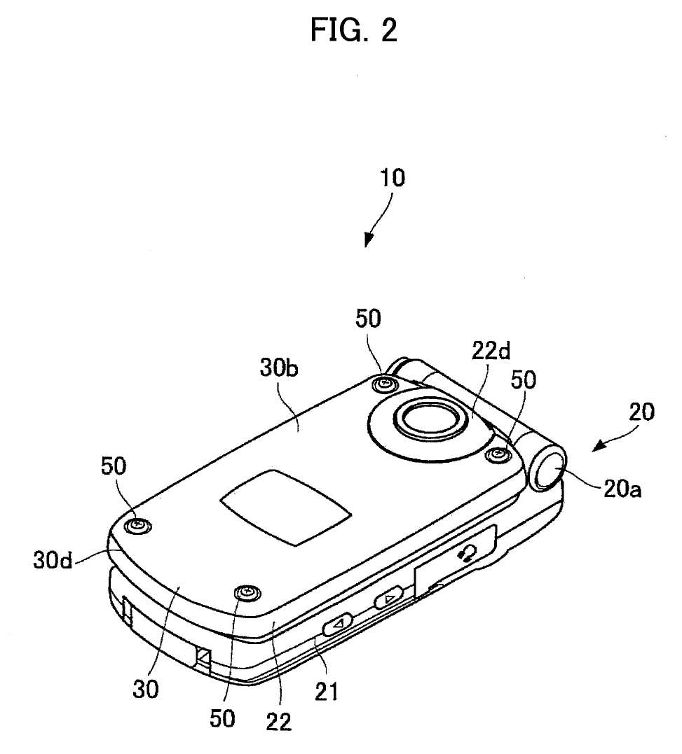

As shown in FIGS. 1 and 2, the cellular phone 10, as an electronic device, according to this embodiment comprises a main body 20, an accessory exterior panel 30 detachably mounted on the main body 20, and four screws 50 for fixing the accessory exterior panel 30 to the main body 20.

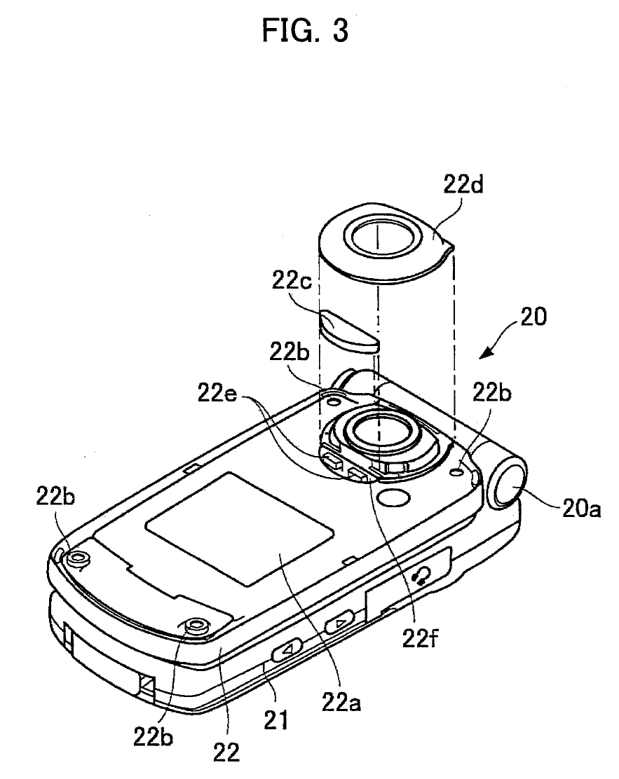

The main body 20 has a case 21, another case 22, and a rotating shaft 20a, the cases 21 and 22 are rotatable around the rotating shaft 20a with respect to each other to ensure that the main body 20 has an opened state and a closed state. The case 21 has, on an inside surface, an operation keys for receiving operations by an operator, and a mouthpiece, neither of which is shown in the drawings, the inside surface held in face-to-face relationship with the case 22 under the condition that the main body 20 is in closed state. The case 22 has, on an inside surface, a main-liquid crystal display portion for displaying a variety of information, and an earpiece, neither of which is shown in the drawings, the inside surface held in face-to-face relationship with the case 21 under the condition that the main body 20 is in closed state. The case 22 further has, on an outside surface, a sub-liquid crystal display portion 22a for displaying a variety of information, four female screw portions 22b to respectively have four screws 50 screwed thereto, a light guide plate 22c, and a cover 22d for covering the light guide plate 22c, the outside surface facing opposite to the case 21 under the condition that the main body 20 is in closed state, that is to say, the side held in contact with the accessory exterior panel 30. As shown in FIG. 3, the case 22 further has two LEDs (Light Emitting Diode) 22e each to emit a light to the light guide plate 22c, and a printed circuit board to have the LEDs 22e mounted thereon, the LEDs 22e and the light guide plate 22c accommodated in the case 22. The light guide plate 22c is adapted to guide, to the outside of the case 22, the light emitted by the LEDs 22e, the light guide plate 22c partly constituting the light emitting portion. As shown in FIGS. 1 and 2, the light guide plate 22c is positioned to emit a light to the inner portion of the accessory exterior panel 30 through the side surface 30a of the accessory exterior panel 30.

The accessory exterior panel has four through bores to have four screws 50 penetrated therethrough, respectively.

The following description will be directed to the operation of the cellular phone 10.

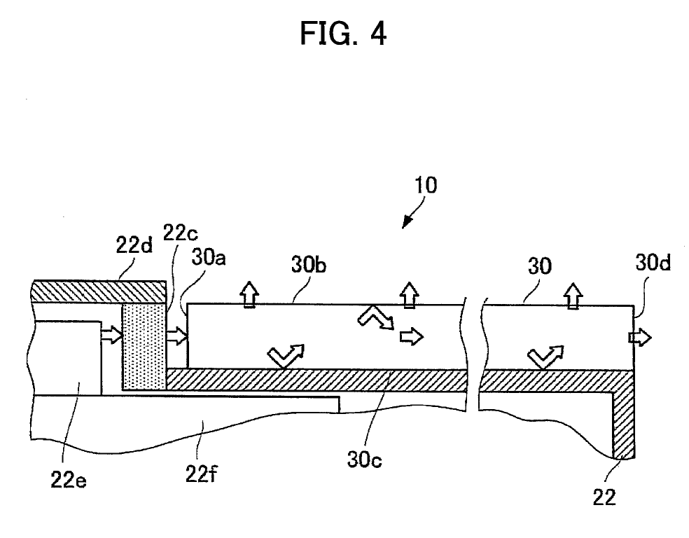

As shown in FIG. 4, the LEDs 22e each emits a light to the light guide plate 22c when there is an incoming call. The emitted light is guided by the light guide plate 22c to the outside of the case 22, and then incident to the inner portion of the accessory exterior panel 30 through the side surface 30a of the accessory exterior panel 30, which results in the accessory exterior panel 30 shone by the light. Here, the outline arrows in FIG. 4 represent traveling directions of the light.

The light incident to the inner portion of the accessory exterior panel 30 through the side surface 30a of the panel 30 is transmitted in the accessory exterior panel 30 with the light reflected by the outside surface 30b and the inside surface 30c, and outputted through the outside surface 30b and the side surface 30d under the condition that the outside surface 30b and the inside surface 30c are transparent. In this case, the closer the area of the outside surface 30b is to the light guide plate 22c, the brighter the area of the outside surface 30b of the accessory exterior panel 30 is.

The cellular phone 10 can increase the visibility by having the whole outside surface 30b of the accessory exterior panel 30 shone more brightly under the condition that the whole inside surface 30c of the accessory exterior panel 30 is light reflectable. This stems from the fact that the light, transmitted from the side surface 30a of the accessory exterior panel 30 to the inner portion of the accessory exterior panel 30, is reflected by the area of the inside surface 30c of the accessory exterior panel 30 with light-reflectivity, and then outputted from the accessory exterior panel 30. Here, the light-reflectivity of the inside surface 30c is achieved by any methods, such as for example, a method of printing on the inside surface 30c of the accessory exterior panel 30 a material with high light-reflectivity, the printing exemplified by a white printing to print a white material and a metallic printing to print a metallic material, a method of forming on the inside surface 30c of the accessory exterior panel 30 fine concavities and convexities with the process of graining, and a method of printing a material with high light-reflectivity over the fine concavities and convexities formed by the process of graining.

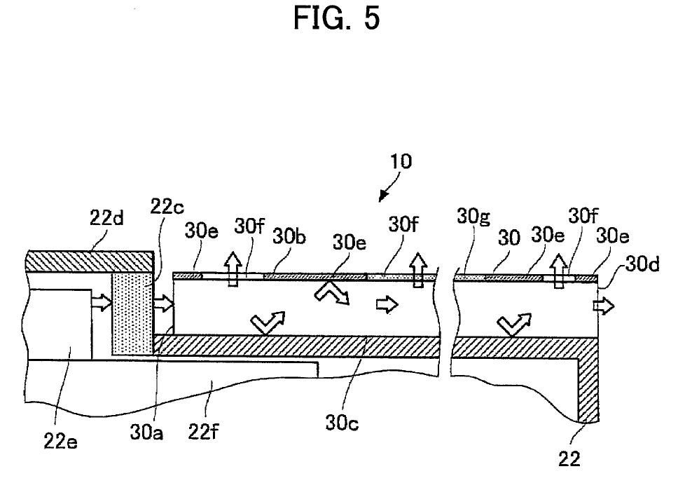

The cellular phone 10 can increase the visibility by having the specific area of the outside surface 30b of the accessory exterior panel 30 shone more brightly under the condition that the outside surface 30b of the accessory exterior panel 30 is partly light shieldable as shown in FIG. 5, resulting from the fact that the light transmitting the inner portion of the accessory exterior panel 30 can be outputted from the outside surface 30b only through areas 30f other than the light shielding areas 30e. Here, the outline arrows in FIG. 5 represent traveling directions of the light. The light shielding areas 30e of the outside surface 30b of the accessory exterior panel 30 are formed with a method of printing on the outside surface 30b of the accessory exterior panel 30 a material having high reflectivity. The cellular phone 10 may have an accessory exterior panel 30 with one or more areas of the outside surface 30b being light shieldable under the condition that the whole inside surface 30c of the accessory exterior panel 30 is light reflectable.

The cellular phone 10 can increase the visibility by having the specific area of the outside surface 30b of the accessory exterior panel 30 shone to be colored under the condition that the areas 30f with light permeability are partly colored, as shown in FIG. 5. This results from the fact that part of the light transmitting the inner portion of the accessory exterior panel 30 is outputted through a colored area 30g having light permeability. The colored area 30g, which is light permeable, of the outside surface 30b of the accessory exterior panel 30 is formed with a method of printing on the outside surface 30b of the accessory exterior panel 30 a material which is highly light permeable and colored.

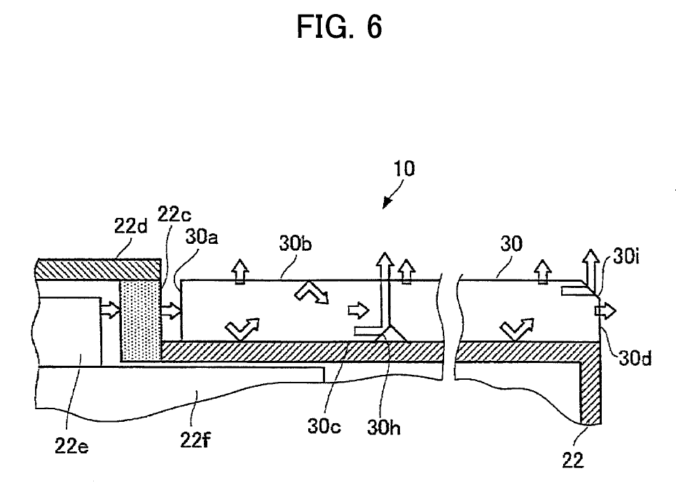

The cellular phone 10 may, as shown in FIG. 6, have an accessory exterior panel 30 having an inclined surface 30h and another inclined surface 30i on a path of the light emitted to the inner portion of the accessory exterior panel 30 from the light guide plate 22c through the side surface 30a. In this case, the inclined surfaces 30h and 30i of the accessory exterior panel 30 are intended to have the light outputted from the accessory exterior panel 30 by reflecting the light traveling the inner portion of the accessory exterior panel 30 which is incident from the side surface 30a of the accessory exterior panel 30. This makes it possible for the cellular phone 10 to increase the visibility by having the specific areas of the outside surface 30b of the accessory exterior panel 30 shone more brightly, the specific areas close to the inclined surfaces 30h and 30i. Here, the outline arrows in FIG. 6 represent traveling directions of the light.

As described in the above, the cellular phone 10 can have, without deteriorating the effect of notification by light, the extended area to have electronic parts mounted thereon at the portion of the main body 20 covered with the accessory exterior panel 30, the extended area being extended in size compared with the conventional cellular phone. This stems from the fact that the light guide plate 22c is positioned to emit the light to the inner portion of the accessory exterior panel 30 through the side surface 30a of the accessory exterior panel 30. The cellular phone 10 can, therefore, have the sub-liquid crystal display portion mounted on a portion of the main body 20, the portion covered by the accessory exterior panel 30.

In addition, the cellular phone 10 can have a stylish appearance even with the accessory exterior panel 30 detached, due to the fact that the accessory exterior panel 30 is mounted on a portion of the main body 20 where the light guide plate is not mounted. This results in the fact that the user can carry the cellular phone 10 while making the cellular phone 10 small in thickness by detaching the accessory exterior panel 30. Furthermore, the user can use the cellular phone 10 with the accessory exterior panel 30 being detached when the user does not want the cellular phone to be shone over a wide area resulting from the fact that only the light guide plate 22c is shone when the accessory exterior panel 30 is detached.

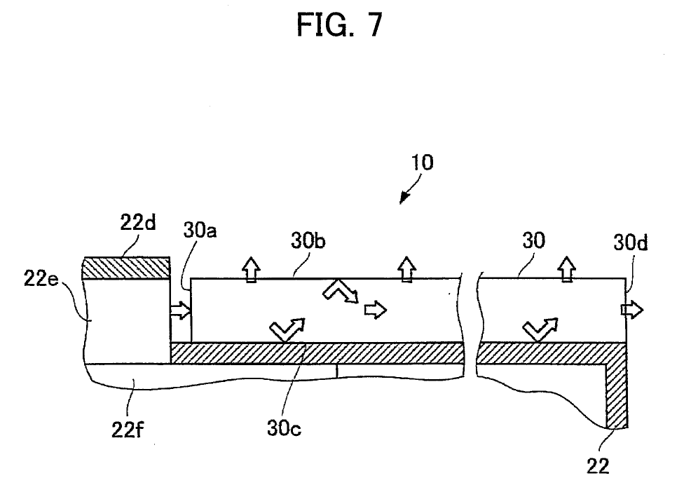

While there has been described about the fact that the light guide plate 22c of the cellular phone 10 shown in FIGS. 1 to 6 is positioned to emit a light to the inner portion of the accessory exterior panel 30 through the side surface 30a of the accessory exterior panel 30, the cellular phone 10 may have one or more LEDs 22e each positioned to emit a light to the inner portion of the accessory exterior panel 30 without the light passing though the light guide plate 22c, as shown in FIG. 7. In other words, the cellular phone 10 may comprise LEDs 22e, as a light emitting portion, each positioned to emit a light to the inner portion of the accessory exterior panel 30 through the side surface 30a. Here, the outline arrows in FIG. 7 represent traveling directions of the light.

Furthermore, the cellular phone 10 may have one or more additional accessory exterior panels, other than the accessory exterior panel 30, mounted on the accessory exterior panel 30.

### Second Embodiment

The constitution of the electronic device according to the second embodiment of the present invention will hereinafter be described in detail.

The constitutional elements of the electronic device according to this embodiment which are the same as the cellular phone 10 (see FIG. 1) of the first embodiment will bear the same reference numerals and legends as those of the first embodiment.

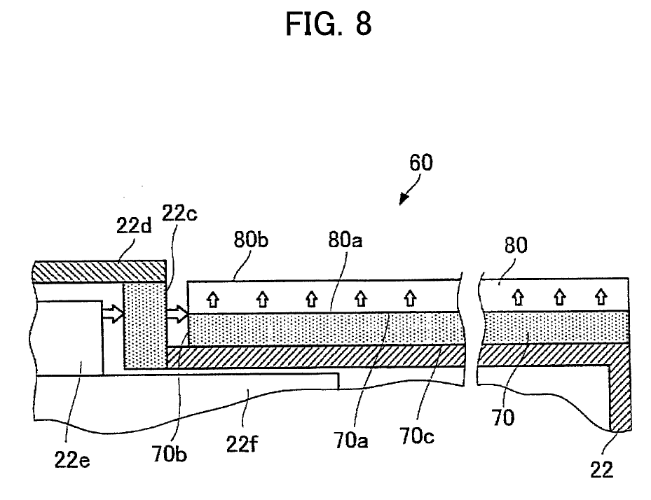

As shown in FIG. 8, the cellular phone 60, as an electronic device, according to this embodiment comprises an accessory exterior panel 70, as a first accessory exterior panel, detachably mounted on the main body 22, and another accessory exterior panel 80, as a second accessory exterior panel, detachably mounted on the outside surface 70a of the accessory exterior panel 70. This constitution is equivalent to the cellular phone 10 with the accessory exterior panel 30 (see FIG. 1) replaced by the accessory exterior panels 70 and 80. Here, the outline arrows in FIG. 8 represent traveling directions of the light.

The light guide plate 22c is positioned to emit a light to the inner portion of the accessory exterior panel 70 through the side surface 70b of the accessory exterior panel 70.

The accessory exterior panel 70 has four through bores to have four screws 50 (see FIG. 1) penetrated therethrough, respectively, the through bores not shown in the drawing. The accessory exterior panel 70 has a thickness approximately half compared with the thickness of the accessory exterior panel 30.

The accessory exterior panel 80 has four through bores to have four screws 50 penetrated therethrough, respectively, the through bores not shown in the drawing. The accessory exterior panel 80 has a thickness approximately half compared with the thickness of the accessory exterior panel 30.

The following description will be directed to the operation of the cellular phone 60.

The LEDs 22e each emits a light to the light guide plate 22c when there is an incoming call. The emitted light is guided by the light guide plate 22c to the outside of the case 22, and emitted to the inner portion of the accessory exterior panel 70 through the side surface 70b of the accessory exterior panel 70.

The light emitted to the inner portion of the accessory exterior panel 70 is transmitted in the accessory exterior panel 70, and reflected by the fine concavities and convexities formed on the inside surface 70c. The reflected light is then outputted through the outside surface 70a. The light is then incident to the inner portion of the accessory exterior panel 80 through the inside surface 80a of the accessory exterior panel 80, which results in having the accessory exterior panel 80 shone.

As described in the above, the cellular phone 60 can make the outside surface 80b of the accessory exterior panel 80 shone more brightly to ensure that the visibility is increased compared with the cellular phone 10 having only one accessory exterior panel 30. This results from the fact that the accessory exterior panel 70 can guide the light, emitted to the inner portion of the accessory exterior panel 70 through the side surface 70b of the accessory exterior panel 70, to the accessory exterior panel 80, and the accessory exterior panel 80 can output the light which is incident to the inner portion of the accessory exterior panel 80 through the inside surface 80a of the accessory exterior panel 80.

In addition, the cellular phone 60 can have, without deteriorating the effect of notification by light, the extended area to have electronic parts mounted thereon at the portion of the main body 20 covered with the accessory exterior panel 70, the extended area being extended in size compared with the conventional cellular phone. This stems from the fact that the light guide plate 22c is positioned to emit the light to the inner portion of the accessory exterior panel 70 through the side surface 70b of the accessory exterior panel 70.

The cellular phone 60 may have an accessory exterior panel 80 with a part of the outside surface 80b light shieldable. The cellular phone 10 may have a specific area in the outside surface 80b of the accessory exterior panel 80, which is light permeable and colored, in a similar manner with the cellular phone 10.

The cellular phone 60 may further have one or more additional accessory exterior panels, in addition to the accessory exterior panel 70 and the accessory exterior panel 80, to be mounted on the accessory exterior panel 80.

### INDUSTRIAL APPLICATION OF THE PRESENT INVENTION

In accordance with the present invention, there is provided an electronic device which can have, without deteriorating the effect of notification by light, the extended area to have electronic parts mounted thereon at the portion of the main body 20 covered with the accessory exterior panel 30, the extended area being extended in size compared with the conventional electronic device, the electronic device being available for a cellular phone.

What is claimed is:

1. An electronic device, comprising:
a main body having a light emitting portion; and
an accessory exterior panel having a side surface and detachably mounted on said main body with said side surface held in face-to-face relationship with said light emitting portion, said light emitting portion positioned in said main body to emit a light to the inner portion of said accessory exterior panel through said side surface of said accessory exterior panel.

2. An electronic device as set forth in claim 1, in which
said accessory exterior panel has an inclined surface formed on a path of said light emitted to said inner portion of said accessory exterior panel from said light emitting portion through said side surface.

3. An electronic device as set forth in claim 1, in which
said accessory exterior panel has an inside surface held in contact with said main body and partly light reflectable.

4. An electronic device as set forth in claim 1, in which
said accessory exterior panel has an outside surface opposite to said inside surface and partly light shieldable.

5. An electronic device as set forth in claim 1, in which
said accessory exterior panel has an outside surface opposite to said inside surface partly light permeable and colored.

6. An electronic device, comprising:
a main body having a light emitting portion;
a first accessory exterior panel having a side surface and detachably mounted on said main body with said side surface held in face-to-face relationship with said light emitting portion; and
a second accessory exterior panel detachably mounted on said first accessory exterior panel,
said light emitting portion positioned in said main body to emit a light to the inner portion of said first accessory exterior panel from said side surface of said first accessory exterior panel, and said first accessory exterior panel functioning as a light guiding member for guiding said light from said light emitting portion to said second accessory exterior panel.
